(19) United States
(12) Patent Application Publication
(10) Pub. No.: US 2008/0059255 A1
(43) Pub. Date: Mar. 6, 2008

(54) Method And System For Distribution Of Revenue

(75) Inventor: Ian Birkby, New South Wales (AU)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: AZOM.COM PTY LTD., Mona Vale NSW (AU)

(21) Appl. No.: 10/598,113

(22) PCT Filed: Feb. 18, 2005
(86) PCT No.: PCT/AU05/00213

§ 371 Date: Aug. 17, 2006

Related U.S. Application Data
(60) Provisional application No. 60/545,746, filed on Feb. 18, 2004.

(30) Foreign Application Priority Data
Feb. 18, 2004 (AU) 2004900825
Dec. 13, 2004 (AU) 2004101054

(51) Int. Cl. G06Q 10/00; G06Q 30/00

(52) U.S. Cl. 705/7; 705/39

(57) ABSTRACT

A method for the distribution of an advertising revenue stream derived from a media space such as a web site. The media space included advertising and content that may be peer reviewed. Distributed of revenue, in one form, includes the step of calculating revenue distributions from the advertising revenue stream to both a provider of the content and the peer reviewer. At least the revenue distribution to the content provider is influenced by a metric indicative of the popularity of the content.

### FIELD OF THE INVENTION

The present invention relates generally to managing a media space and more specifically to the distribution of revenue generated from advertisements in that media space. In the context of the invention, the term “media space” relates to publications containing content such as articles, scientific papers, information listings, images, video, software and the like that are distributed or operate in any one or more of various forms, such as in print, on a computer readable media, or accessible over a computer network such as the Internet. The invention has been developed especially, but not exclusively, for a media space that is accessible over the Internet, and the invention is herein described in that context.

### BACKGROUND OF THE INVENTION

Media space that provides content and receives revenue from advertising and which is operated over the Internet is known. To successfully increase revenue in this media space, different schemes have been proposed to charge for advertising space. On scheme know as “content targeted marketing” enables advertising to be targeted to a reader who is viewing content related to the advertiser's products or services. An example of such a system can be found at www.google.com where advertisers can associate their products or services with selected keywords and charges are based on a cost-per-click and are generated as revenue for the search engine provider.

Whilst these charging schemes have been successful, there is an ongoing need to provide mechanisms to encourage content and/or advertising revenue to a media space.

### SUMMARY OF THE INVENTION

A first aspect of the invention relates to a method for the distribution of an advertising revenue stream derived from a media space incorporating content that is peer reviewed and advertising, the method comprising the step of calculating revenue distributions from the advertising revenue stream to be distributed to both a provider of the content and the peer reviewer, at least the revenue distribution to the content provider being influenced by a metric indicative of the popularity of the content.

This method of distribution provides a relationship between the income generated by the publisher or broadcaster of the media space through advertising and the income derived by the content provider that is based on the popularity of the content, and the peer reviewer of the content. This relationship thereby provides a system where the income for different content, and possibly the peer reviewer, in a media space will vary so as to enable providers that are submitting content that contributes more to the popularity of the media space to be better rewarded.

By arranging a system where a peer reviewer obtains revenue from advertising in the media space provides an incentive to attract peer reviewers and thereby improves the quality of content. In scientific publications in particular, the peer review panel is an important aspect of the content.

In one form, the method further comprising the steps of establishing the metric indicative of the popularity of the content based on at least one attribute associated with the content; monitoring the at least one attribute; establishing the value of the metric based on an output from monitoring the at least one attribute; and using the value of the metric in calculating the revenue distribution.

In one form, the distribution to the peer reviewer is also influenced by the value of the metric indicative of the popularity of the content. This thereby provides an incentive to attract peer reviewers to review popular content and hence increase the amount of quality content available in popular content areas.

In the context of the invention, the content provider is typically the author or owner of the content. However, it is to be appreciated that the content provider could be another entity having some other relationship with the content, the exact nature of that relationship not being important to the invention. Similarly, the peer reviewer is typically the person or panel who undertakes the actual review of the content. However, it is to be appreciated that the peer reviewer could be another entity having some relationship with the reviewer of the content.

In a specific embodiment, a predetermined association is established between the content and advertising in the media space.

The predetermined association of the advertising to content in the media space may be on the basis of a one to one relationship or on a one to many relationship where the content is associated with a plurality of advertising in the media space.

An example of a one to one relationship is where the content is associated with content having a unique identifier. An advertiser may associate their advertising with a specific piece of content in the media space. This type of association can be charged at a premium rate.

An example of the one to many relationship is where the content is associated with advertising through keywords. In that arrangement, characteristics in the form of keywords are assigned to a piece of content based on its subject matter and in turn, advertises select certain keywords to which they wish to be associated with. In this way, a piece of content may be linked through a keyword to a plurality of advertisements and vice versa. These characteristics can be inherent to the content or may be information attributed to the content during peer review.

In a particular embodiment, the predetermined association has a bearing on the distribution of the revenue to the content provider and in some instances to the peer reviewer.

In accordance with various embodiments of the invention, one or more metrics are established to provide a measure indicative of the popularity of the content. This metric can take many different forms depending on the type of media space and whether the popularity of the content is measured in absolute terms, or as a comparative measure between different content, media spaces or over different time periods.

In the arrangement where the media space is a web site, embodiments of the invention may have the attribute as the content viewing date and the metric is a count of the number of times a specific content item has been viewed in a time period, thus providing an absolute measure of popularity. In a more specific embodiment, this calculated metric for each specific content item can then be used to calculate the relative or comparative measure of popularity of each item. These measures of popularity can then be used in calculating the revenue distribution.

Attributes used in alternate embodiments include the content viewing time. In these embodiments, the metric is the sum of the viewing time of a specific content item in the time period. Both absolute and relative popularity measurements can then be calculated.

Other embodiments can use as the attribute the number of times an advertisement was clicked whilst a specific content item was being viewed. The metric calculated is a count of the advertisement clicks for each specific content item in the time period.

Other attributes can also be used in the aggregation and calculation of metrics. For example, the IP address or the domain name of the request for a specific content item can be used to break down the demographics of the requests by country. These attributes, when used in the measurement of popularity can then be used to calculating the revenue distribution on the basis of target markets.

The metrics can also be compared between time periods to calculate further metrics that characterise the popularity of the content. For example a rate of change in popularity determined from one or more metrics can be derived as a further metric.

In another arrangement, a weighting may be applied to a portion of the revenue which is made available to the content provider, based on the type of predetermined association. For example, a one to one relationship may have a higher weighting thereby allowing the content provider to obtain more revenue based on a particular popularity of the content than would occur for the same content on a one to many relationship. This would thereby increase the percentage of the revenue stream distributed to the content provider.

The popularity of the content may be measured on a continual basis or during a discrete period with the revenue streams being calculated and distributed also on a periodic basis. Also, it is to be appreciated that the period during by which the popularity of the content is measured, and the revenue to be distributed may vary depending on preferred designs of the system.

The calculated distribution can distributed by many methods such as the printing and posting of cheque, direct deposit into a bank account or internet based money transfer such as secure transfer of funds to an internet based member account. Alternatively, calculated distribution for a recipient can accumulate within an account and then the recipient can request transfer of the accumulated distribution to a selected target account.

A second aspect of the invention relates to a method for the distribution of an advertising revenue stream derived from a media space incorporating content and advertising, the method comprising the steps of:
establishing a plurality of revenue pools from the advertising revenue stream; and
associating the content with at least one of the revenue pools, wherein the provider of content receives a revenue distribution which is at least partially dependent on the value of the at least one revenue pool to which the content is associated

In one form, the revenue pools are defined by at least one characteristic which is capable of distinguishing content in the media space. In a particular embodiment, this at least one characteristic may be content subject matter. However, it may be other characteristics such as author related, the significance or other attribute of the content, or the like.

In one form, the content is peer reviewed and wherein the content is associated with the revenue pools by assigning the at least one characteristic to the content by peer review.

In one form, advertising is associated with the revenue pools and this determines at least in part, the value of that revenue pool. This selection or nomination of the advertising may be based on the at least one characteristic.

As an example of this arrangement, the revenue pool that is available to a content provider and peer reviewer may be based, at least in part, on the advertising revenue generated from advertising to which the content is associated. The distribution of the advertising revenue to the revenue pools may be made through a keyword or topic link that is indicative of the characteristic of the revenue pool and which links the advertising to the content. Accordingly, content that is more popular with advertisers has a larger pool from which to draw revenue. In this way, the mechanism provides incentive for content providers to submit content which is sought after by advertisers and for review of that content by peers.

A third aspect of the invention relates to a method for the distribution of an advertising revenue stream derived from a media space incorporating content and advertising, the method comprising the steps of:
establishing a plurality of revenue pools from the advertising revenue stream;
publishing the value of each revenue pool; and
associating the content with at least one of the revenue pools, wherein the provider of content receives a revenue distribution which is at least partially dependent on the value of the revenue pools to which the content is associated.

The publication of the size of the revenue pool enables content providers to see the size of the revenue pool in different content areas and thereby target their contributions to the advertisers and public interest. In the case of academic publishing, this can also assist in providing direction to not just publication of content but the focus for future research.

In one form, the revenue pool may include a part which is general to all content in the media space.

For each of the aspects of the invention, specific embodiments of the invention include a computer program arranged, when loaded on a computing system, to perform the method in any form as described above. Embodiments can also include a computer readable medium providing said computer program.

### BRIEF DESCRIPTION OF THE DRAWINGS

Not withstanding any other forms which may fall within the scope of the present invention, preferred forms of the invention will now be described, by way of example only, with reference to the accompanying drawings in which:

FIG. 1 illustrates a first embodiment of the revenue distribution system;

FIG. 2 illustrates a second embodiment of the revenue distribution system;

FIG. 3a, 3b and 3c show sample calculations for the distribution of revenue;

FIG. 4 illustrates a search page;

FIG. 5a, 5b and 5c illustrates keywords generated in three respective categories;

FIG. 6a and 6b illustrate respectively a conceptual layout of a web page and a sample rendered page including advertisements;

FIG. 7 illustrates a popularity report;

FIG. 8a is a schematic diagram of a computing system suitable for use with an embodiment of the present invention;

FIG. 8b is a cluster of computing systems on which an embodiment in accordance with the invention may be executed; and

FIG. 9 illustrates a third embodiment of the revenue pool distribution system.

### DETAILED DESCRIPTION

The following embodiments relate to schemes to distribute advertising revenue to content providers of a media space 50. In these embodiments, the media space is provided on a computer network such as the Internet, and is operated through conventional client server computer architecture incorporating a web server and database with the media space being accessible to consumers through a web site 60.

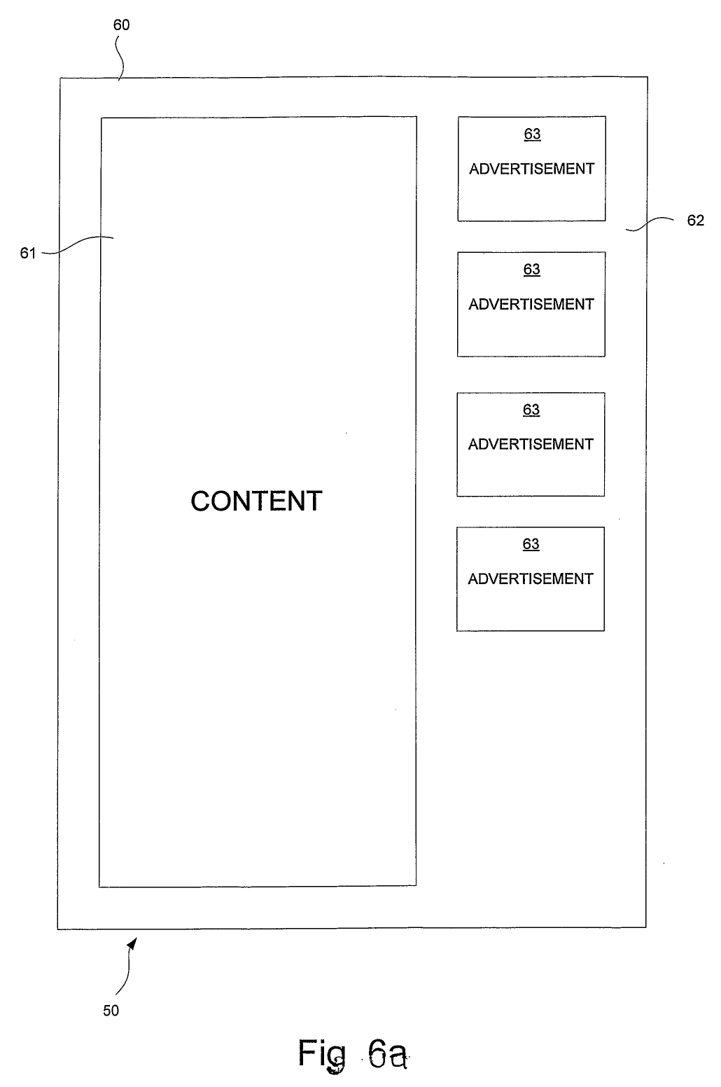

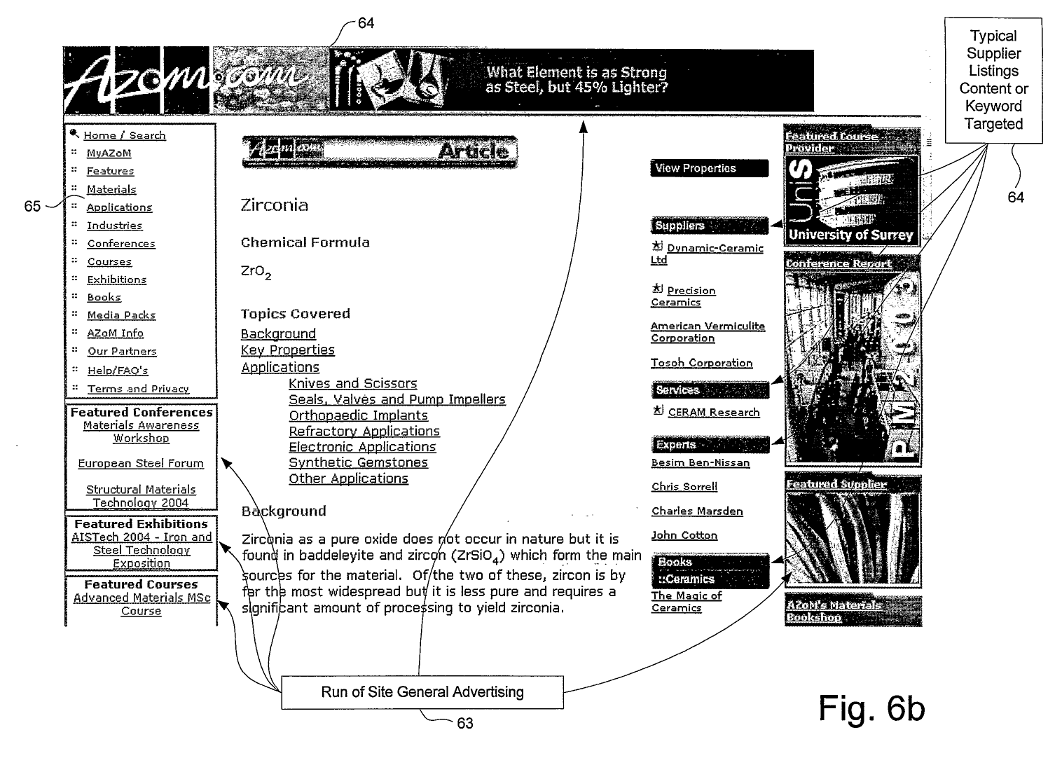

The media space 50 is illustrated in FIG. 6a in the form of a rendered web page 60. The web page 60 contains content 61 and advertising 62 made up of a plurality of advertising elements 63, 64. Some of the advertising elements 63 are specifically related to the content 61, whereas other forms of the advertising 64 is not targeted and is of a general nature. For those skilled in the art, the concept of a media space is not limited to a web space, it can be applied to other mediums such as print and interactive television.

FIG. 6b shows a screen-shot of the web page 60 incorporating the content 61 and the advertising 62. In the illustrated form, the content relates to the material Zirconia and some of the advertising 63 is specifically targeted to this technical field. This advertising includes suppliers of the material, experts working in the field, and particular books which are related to this subject matter. Some of the other advertising 64 is general advertising and includes the banner element across the top of the web page as well as other elements relating to more general subject matters. The web page 60 also includes other additional elements such as the navigation element 65.

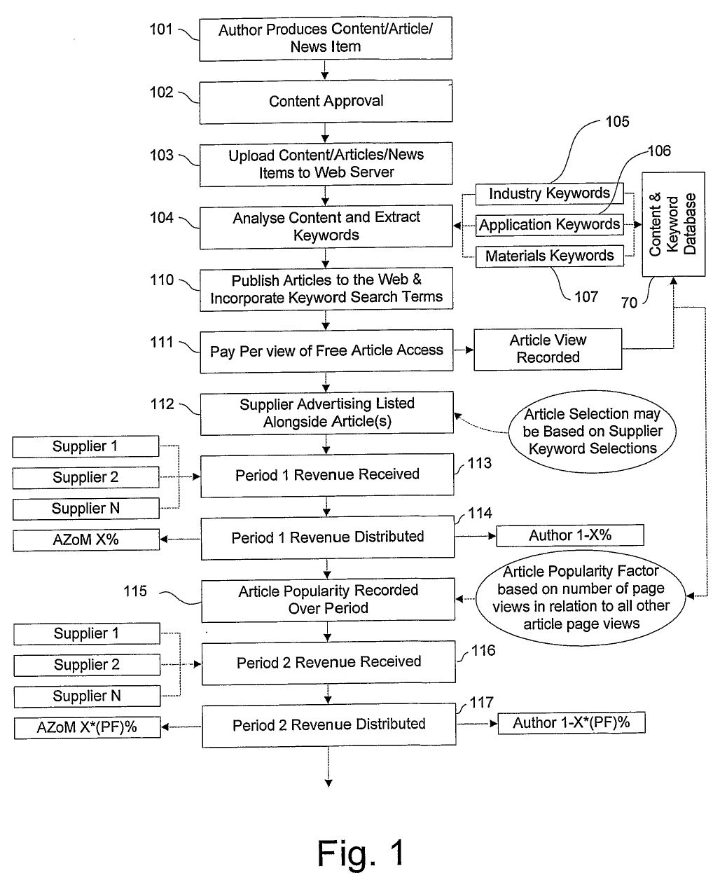

FIG. 1 is a simplified block diagram which illustrates a method of distributing advertising revenue to the content providers in the media space 50.

At step 101 a content provider producers content for publication on the web site 50. Consistent with the embodiment shown in the FIGS. 6a and 6b, the content is of a technical and scientific nature, however it is to be appreciated that it could equally apply to content of any subject matter. At step 102, the content is approved, typically by peer review, for publication and at step 103 the content is uploaded to the web server.

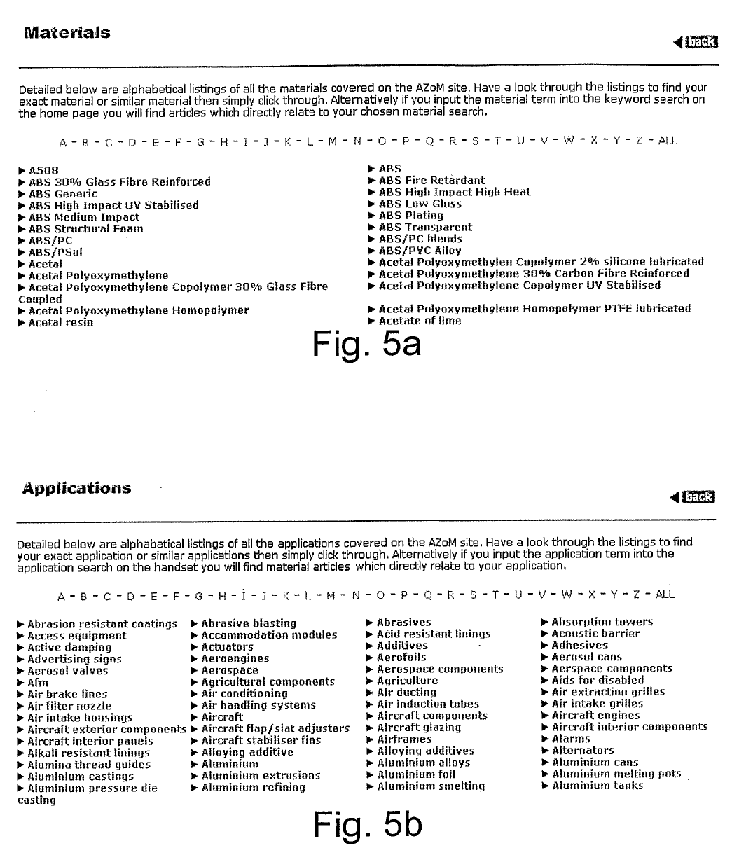

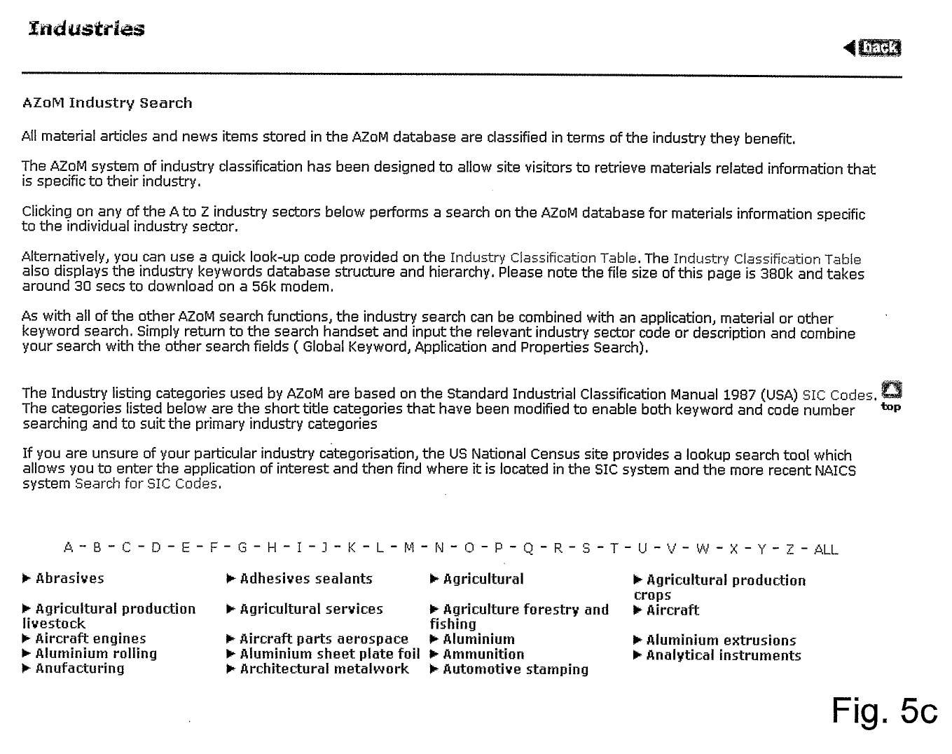

After uploading, at step 104, the information in the uploaded content is assigned characteristics such as keywords. In this specific embodiment, the information is analysed to extract the keywords and three separate categories of keywords are extracted. Each of steps 105, 106 and 107 extract industry, application and material keywords respectively. Examples of the keywords generated are illustrated in the screen shots in FIG. 5a, 5b and 5c where the three categories of keywords generated from content are shown. FIG. 5 shows an example of the various categories of keywords. In FIG. 5a materials keywords, in FIG. 5b application keywords and in FIG. 5c industry keywords are shown. It is to be appreciated that keywords may be assigned to the content other than through an analysis of the information uploaded with the content. Other characteristics include the affiliation of the content author, author specialisation and a rating of the content.

Once the keywords have been assigned to the content they are then stored in a keyword and content database 70.

Once the keywords are stored, at step 110, the content is made accessible on the web site and can be found via a search using the assigned keywords or other browsing means.

The content may be accessible to customers either as a free article access or by way of a pay per view arrangement. At step 111, each time the content is requested for viewing in the media space, a register in the keyword and content database 70 is altered to record the request. The register is in the form of a log file record in which many details of the request including host name, RPC931 identity of the client, and the time of request. This data is used to derive attributes associated with the content. The monitoring of these attributes is used as a measure of popularity of the content to produce a popularity factor as will be explained in more detail below.

At step 112, advertising 62 is rendered in the media space with the content. As indicated above, some of the advertising elements 63 are targeted to the content and the selection of those advertisements which are rendered with the content is determined by a predetermined association with the content, which is typically done through the keywords assigned to the content.

This predetermined association can be at various levels. In one form, an advertiser can associate an advertisement with a specific piece of content. This establishes a one to one relationship between the advertisement and the content. When the content is requested, the association with the content provides an increased likelihood of placement in the advertising element in the media space. It should be noted that the advertisement can establish a one to one relationship with more than one piece of content. In a second form, an advertiser may nominate specific keywords that they are interested in and advertising is matched with content based on a matching of keywords selected by the advertiser and the keywords assigned to the content. Through this mechanism, a one to many relationship is established in that one piece of content may be associated with a plurality of advertising elements. Once again, this association can be stored as a record in a database and through this association, a single keyword provides an increased likelihood of placement of the advertisement in the advertising elements associated with respect to possibly several different contents rendered to the media space.

In a third form, the predetermined association can be managed by a third party. A third party can index the content and establish predetermined associations with the content. On rendering of the page, a request is passed through the third party indicating the content being rendered and a third party can send an advertisement back for inclusion as an advertisement in the rendered media space. In this case, revenue from the advertisers to the publisher with the third party as an intermediary.

Once the advertising and the content in the media space 50 is established, revenue is generated and received at step 113. This revenue may be from generalised advertising, specific targeted advertising, or by virtue of pay per view for the content. The revenue is then distributed at step 114. In the initial period, the revenue is distributed to the content provider without any regard to the popularity of that content as there has not been sufficient time to gauge the popularity. However, during that initial period, the popularity is recorded at step 115 so that in subsequent periods, the popularity can be factored into the revenue distribution to the content provider as will be discussed in more detail below.

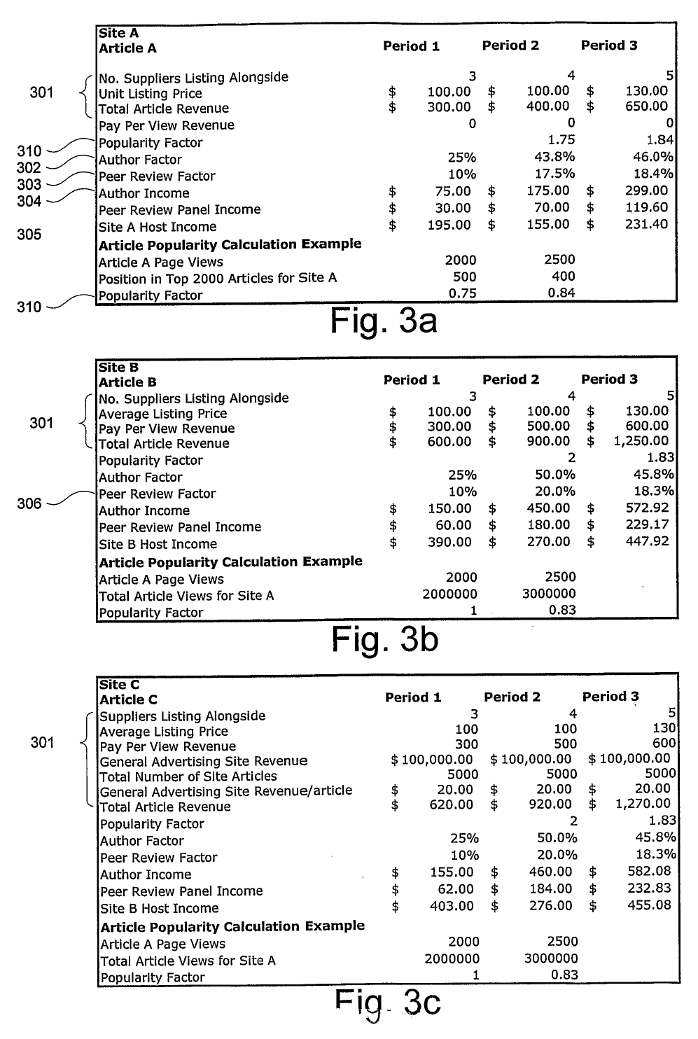

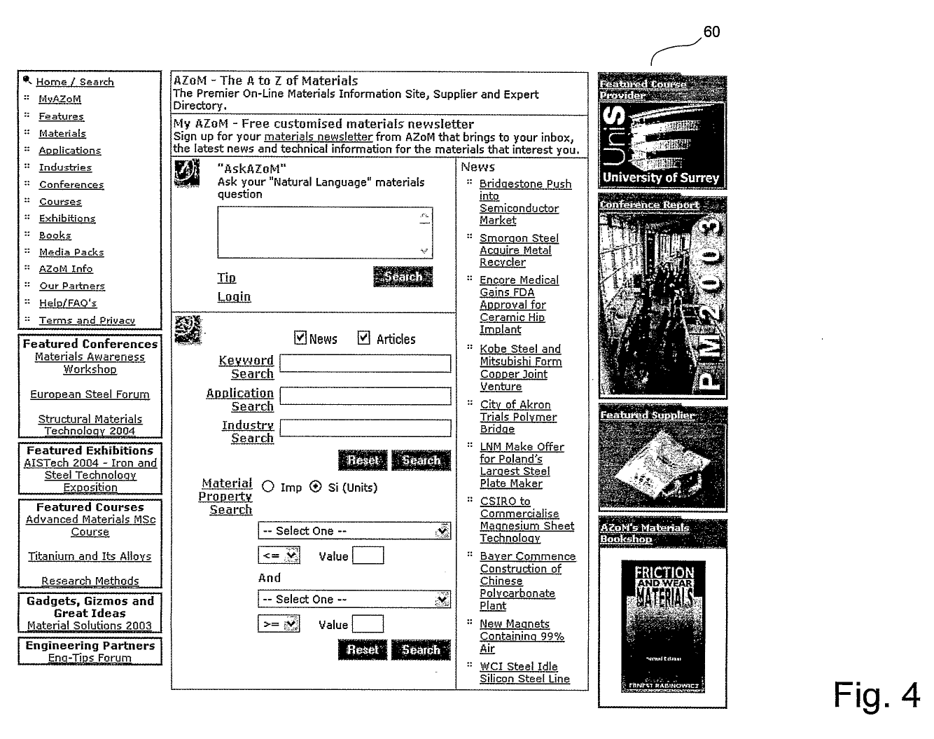

At step 115, the popularity of the content is measured so as to generate a popularity factor 310 (see FIG. 3a). The popularity of the content is calculated based on attributes recorded in the log file records in the keyword and content database 109. In a simple form, the attribute that is recorded in the keyword and content database file 70 is the number of requests for a particular piece of content. FIG. 7 is a content popularity report which illustrates the number of requests (by way of page impressions 71) or different content (as represented by a unique ID 72 and name 73). A metric is then established to generate the popularity factor. In one example, the attributes are used to rank the pieces of content in the media space and the popularity factor is established by dividing the position of the content in the ranking, divided by the total number of articles in the ranking. As it is to be appreciated, different metrics could be used to establish a popularity factor either as a quantitative measure or as an absolute measure. Once the popularity factor is generated for a particular period, the subsequent periods use that popularity factor in the distribution of revenue to the content provider. Specifically, at step 116, revenue is received in the second period, and is distributed in step 117 using an algorithm which utilises the popularity factor. The exact operation of the distribution will be explained in more detail below.

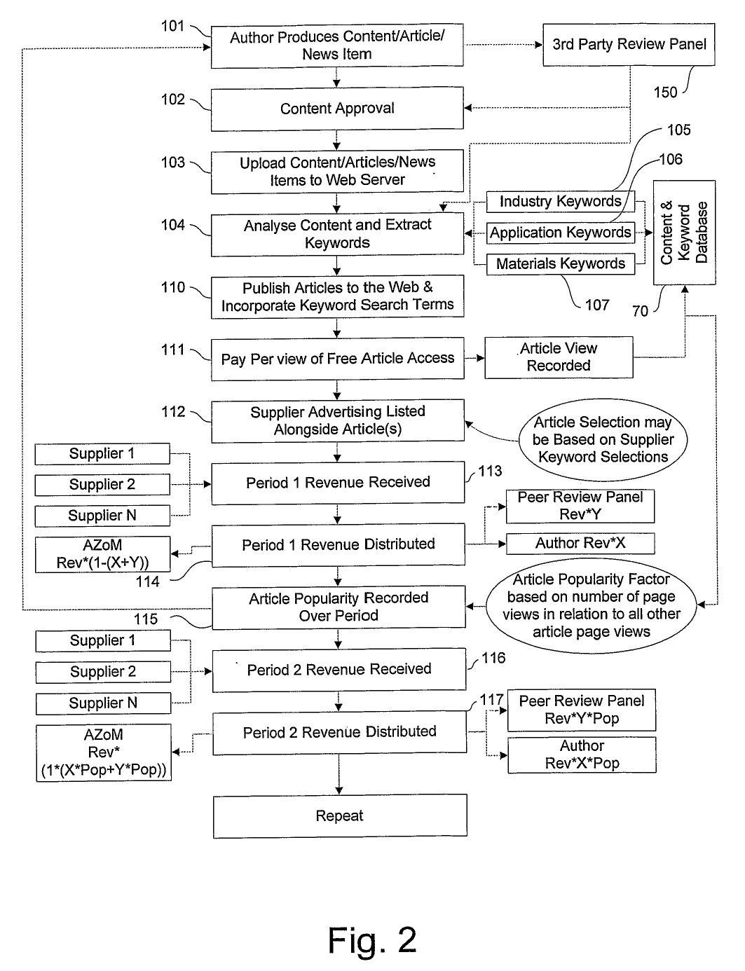

A second embodiment of the methodology is illustrated by the simplified block diagram of FIG. 2. This second embodiment shares many aspects of the first embodiment and like features have been given like reference numerals. The primary difference in the second embodiment is that content goes to a third party peer review at step 150. Typically this peer review is incorporated as part of the content. The peer reviewer also provides a list of peer selected keywords at step 104 thereby enabling those keywords to be included in the content and keyword database 70. The peer selected keywords assist in ensuring that industry specific keywords are identified and properly indexed. Also the peer selected keywords can include words that are not in the content reviewed. For example, the reviewed content may relate to a new technical discovery but the document may not include references to the applications. In this case, a peer reviewer can associate keywords that relate to the new technical discovery to the industry fields it may impact.

A further difference in the second embodiment is that in distributing revenue at steps 114 and 117, a portion of the revenue stream is distributed to the peer review panel. Various mechanisms can be used to establish the portion of the revenue which is distributed and this is described below with reference to examples A, B and C which are illustrated in FIGS. 3a, 3b and 3c.

In example A revenue distribution calculations are made for periods 1, 2 and 3. In example A the revenue which is available for distribution (301) is derived solely from target specific advertising. In this example there is no general advertising nor paid review revenue. In addition, no revenue is distributed for peer review as represented by a 0 in each of the peer review factor 303. However, a portion of the revenue is distributed to the author or content provider at a rate of which is determined by the author factor 302. This author factor is determined based on a base rate (which is example A is 25% multiplied by a popularity factor 310 which in the initial period does not apply).

In looking at example A, in period 1 the revenue which is available for distribution 301 is calculated at $300. By virtue of the author factor in the first period being at 25%, $75 of that income is distributed to the content provider as author income 304 whereas the publisher receives $125 as the host income 305.

In addition, during the first period the popularity of the content is measured and the popularity factor 310 is established. As discussed before, the popularity factor is determined by dividing the position of the ranking of the content by the total number of separate content pieces. In this example, the content ranked 500 out of 2000 thereby giving it a popularity factor of 0.75.

The calculation in subsequent periods 2 and 3 are done on a similar basis to period 1 with the exception that the popularity factor 310 is introduced and thereby affects the percentage of the content which is distributed as author income 304. In period 2 it is seen that the popularity factor 310 is introduced as 1.75 thereby giving an author factor 302 of 43.8%. Also the amount in the revenue pool 301 had increased from $300 to $400 thereby resulting in a distribution of $175. In addition, during the second period the article popularity is calculated to introduce a new popularity factor of 0.84 based on the fact that the content ranked 400 out of a total article pool of 2500. This popularity factor is then used in the third period as represented by 1.84 in the popularity factor 310 for period 3.

Example B includes many similarities of example A. The main differences being that the revenue pool 301 includes pay per view revenue, a peer review factor is introduced and the popularity factor is calculated using slightly different attributes.

In example B the revenue pool 301 includes pay per view revenue which in period 1 is $300. Also a peer review factor is introduced 303 having a base rate of 10%. This peer review factor is also weighted by the popularity factor so that it will increase as the popularity factor 310 is introduced. Finally, the popularity factor is calculated using a different metric. With this calculation, the ratio of the number of page views to the total number of article reviews for the media space times 1000. This gives a popularity factor of 1 for the period 1 and a popularity factor of 0.83. The revenue is then distributed in a consistent manner to that as explained in example A with the addition that peer review panel income 306 is also generated.

Finally in example C, a further arrangement is described whereby the revenue pool 301 also includes general advertising site revenue. In example C, the general advertising site revenue is proportioned amongst all of the content articles which in the present example gives an additional $20 to the revenue pool 301 for each of the periods. The revenue distribution is then calculated based on the same arrangements as shown in example B.

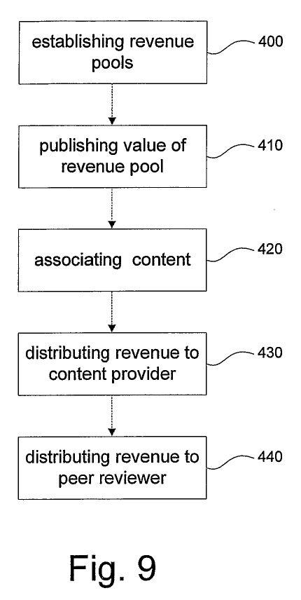

FIG. 9 shows a further embodiment of the revenue distribution system. This embodiment shares many features with the first and second embodiment, but includes the additional step of publishing the value of a revenue pool derived from advertising revenue streams. In this embodiment, revenue pools 400 are established from a plurality of revenue streams. These revenue pools are defined by characteristics such as keywords. These characteristics then can be used to associate content with similar characteristics to the revenue pool. In step 410, the value of the revenue pool is published. As described previously, this publication of the revenue pool enables authors of content to target the creation of content to the popular topic area that are defined by the characteristics of the pools. Content is associated with the revenue pool according to step 420 by peer review assignment of keyword or category. Alternatively, it can be by other characteristics such as words frequency in the document or rating. As with the previous embodiments, revenue distribution steps 430 and 440 distribute revenue to the content provider, and the peer reviewer.

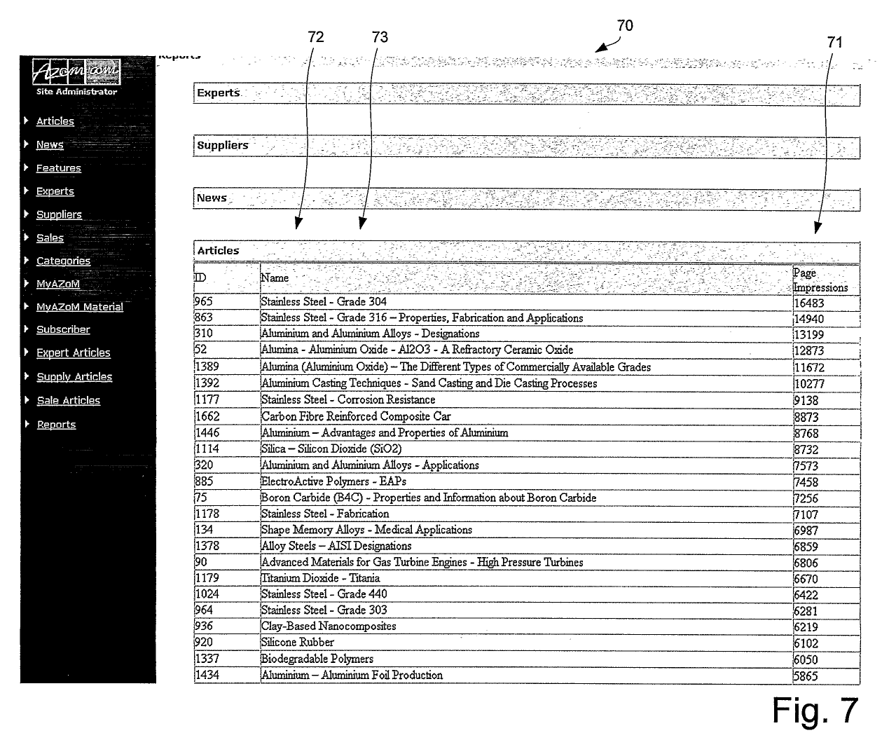

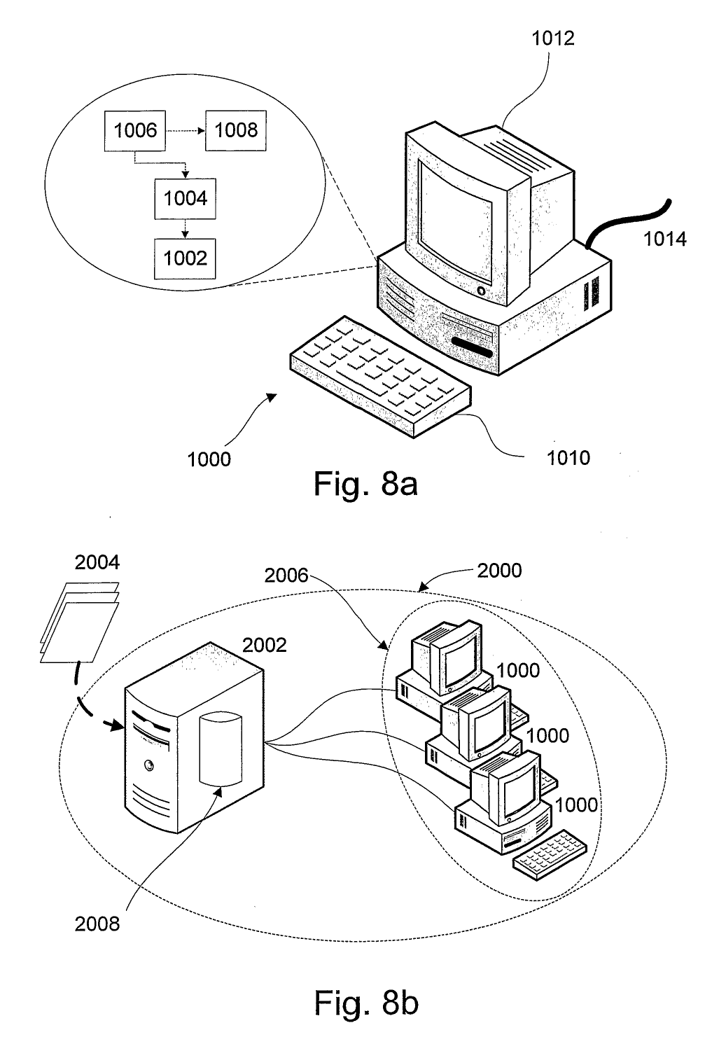

FIG. 8a shows a schematic diagram of a computing system 1000 suitable for use with a embodiments of the invention. The computing system 1000 may be used to execute applications which can receive transaction clusters. The computing system 1000 may include a processor 1002, read only memory (ROM) 1004, random access memory (RAM) 1006, and input/output devices such as disk drives 1008, keyboard 1010, mouse (not shown), display 1012, printer (not shown), and communications link 1014.

The computer includes applications that may be stored in RAM 1006, ROM 1004, or disk drives 1008 and may be executed by the processor 1002. The communications link 1014 connects to a computer network but could be connected to a telephone line, an antenna, a gateway or any other type of communications link.

Disk drives 1008 may include any suitable storage media, such as, for example, floppy disk drives, hard disk drives, CD ROM drives or magnetic tape drives. The computing system 1000 may use a single disk drive or multiple disk drives. The computing system 1000 may use any suitable operating system, such as Windows™ or Unix™.

FIG. 8b is a diagram showing a computing system network 2000 comprising computing systems 1000 of FIG. 8a networked such that data may be interchanged between the networked computer systems. The networked computer system 2000 may include a server 2002 arranged to allocate an incoming transaction cluster 2004 amongst the plurality of computing systems (generally denoted as a collective by numeral 2006). Data related to the transaction cluster 2004 is maintained in one or more databases 2008 contained in storage media controlled by the server 2002.

The embodiments described herein pertains to a method and system for distribution of revenue that could be operated on each of the computing systems 1000 in the plurality of computing systems 2006. The method may be used in heterogeneous networks (i.e. where each of the computing systems 1000 has a different processing ability).

The embodiments are directed to provide a method for distribution of revenue, without requiring the user to have a particular knowledge of the application behavior and/or the architecture of each of the computing systems 1000 in the plurality of computing systems 2006.

It will be understood that the computing system described in the preceding paragraphs is illustrative only, and that embodiments may be executed on any suitable computing system, with any suitable hardware and/or software.

An advantage of the implementation of the methods of the revenue distribution, as described, encourages authors that contribute popular content. The popularity of the content adds to the popularity of the media space which encourages further authors, thus generating more visits to the web site and therefore more revenue. This allows for a greater revenue pool to authors and the site hosts. Similarly, the distribution of revenue to peer reviewers also encourages talented reviewers to contribute.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be appreciated that variations and/or modifications may be made to the parts previously described without departing from the spirit or ambit of the invention.

1. A method for the distribution of an advertising revenue stream derived from a media space incorporating content that is peer reviewed and advertising, the method comprising the step of:
calculating revenue distributions from the advertising revenue stream to be distributed to both a provider of the content and the peer reviewer, at least the revenue distribution to the content provider being influenced by a metric indicative of the popularity of the content.

2. A method according to claim 1, further comprising the steps of:
establishing the metric indicative of the popularity of the content based on at least one attribute associated with the content;
monitoring the at least one attribute;
establishing the value of the metric based on an output from monitoring the at least one attribute; and
using the value of the metric in calculating the revenue distribution.

3. A method according to either claim 1 or 2, further comprising the step of:
establishing a predetermined association between the content and the advertising, wherein at least the calculated revenue distribution to the content provider is also influenced by the predetermined association.

4. A method according to claim 3, further comprising the step of using information provided by the peer reviewer of the content in forming the predetermined association.

5. A method according to either claim 3 or 4, wherein the predetermined association influences the advertising revenue stream that is available for distribution to at least the content provider.

6. A method according to any one of claims 3 to 5, wherein the predetermined association influences the percentage of the revenue stream that is distributed to at least the content provider.

7. A method according to any one of claims 3 to 6, wherein the predetermined association is a one-to-one association with the content.

8. A method according to any one of claims 3 to 6, wherein the predetermined association is a one-to-many association with the content.

9. A method according to any preceding claim wherein distribution of revenue to the peer reviewer is influenced by a metric indicative of the popularity of the content.

10. A method according to any preceding claim further comprising the step of
distributing the calculated revenue distributions.

11. A method for the distribution of an advertising revenue stream derived from a media space incorporating content and advertising, the method comprising the steps of:
establishing a plurality of revenue pools from the advertising revenue stream; and
associating the content with at least one of the revenue pools, wherein the provider of content receives a revenue distribution which is at least partially dependent on the value of at least one revenue pool to which the content is associated.

12. A method according to claim 11, wherein the revenue pools are defined by at least one characteristic which is capable of distinguishing content in the media space.

13. A method according to claim 12, wherein the content is peer reviewed and wherein the content is associated with the revenue pools by assigning the at least one characteristic to the content by peer review.

14. A method according to claim 13 further comprising the step of distributing revenue to the peer reviewer from the at least one revenue pool.

15. A method according any one of claim 11 to 13, further comprising the step of:
publishing the value of each revenue pool.

16. A method according to any one of claim 11 to 15, further comprising the step of:
associating advertising from the media space to be associated with at least one revenue pool, wherein the value of the at least one revenue pool is at least partially dependent on the advertising to which it is associated.

17. A method according to claim 16 when dependent; on claim 12, wherein the advertising is associated with the at least one revenue pool on the basis of the at least one characteristic of the or each revenue pool.

18. A method for the distribution of an advertising revenue stream derived from a media space incorporating content and advertising, the method comprising the steps of:
establishing a plurality of revenue pools from the advertising revenue stream;
publishing the value of each revenue pool; and
associating the content with at least one of the revenue pools, wherein the provider of content receives a revenue distribution which is at least partially dependent on the value of the revenue pools to which the content is associated.

19. A method for the distribution of an advertising revenue stream according to claim 18, wherein each revenue pool is defined by at least one characteristic.

20. A computer program arranged, when loaded on a computing system, to perform the method in accordance with any one of the preceding claims.

21. A computer readable medium providing the computer program in accordance with claim 21.
